(19) United States
(12) Patent Application Publication
(10) Pub. No.: US 2026/0350559 A1
(43) Pub. Date: Nov. 5, 2026

(54) SYSTEM AND METHOD FOR PROVIDING A STOCK MARKET AND ONLINE MARKETPLACE USING BLOCKCHAIN TECHNOLOGIES

(71) Applicant: Matthew Ettswold, Fort Pierce, FL (US)

(72) Inventor: Matthew Ettswold, Fort Pierce, FL (US)

(21) Appl. No.: 19/196,426

(22) Filed: May 1, 2025

(51) Int. Cl. G06Q 20/06; G06Q 40/06

(52) U.S. Cl. CPC G06Q 20/065; G06Q 40/06; G06Q 2220/00

(57) ABSTRACT

A computer-implemented method for managing decentralized business funding may include receiving, via a decentralized application (dApp), a funding proposal from a business entity, the funding proposal including a requested funding amount, funding terms, and intended use of funds; verifying, using a smart contract stored on a blockchain network, that the business entity possesses a verified non-fungible token (NFT) identity including on-chain compliance and performance data; publishing the funding proposal to an investor-facing interface, wherein the proposal is accessible to users based on tiered NFT membership levels; receiving investment commitments from one or more investors via the decentralized application; storing each investment commitment immutably on the blockchain network; executing a smart contract to enforce a binding agreement between the business entity and the investors upon reaching a predetermined funding threshold; and distributing, upon fulfillment of proposal milestones, return payments to the investors using a blockchain-native token.

### CROSS-REFERENCE TO RELATED APPLICATIONS

The present application claims priority to U.S. Provisional Application No. 63/733,481 filed Dec. 13, 2024, titled “SYSTEM AND METHOD FOR PROVIDING A STOCK MARKET AND ONLINE MARKETPLACE USING BLOCKCHAIN TECHNOLOGIES,” which is hereby incorporated by reference in its entirety.

### TECHNICAL FIELD

The embodiments generally relate to the technical field of decentralized finance and blockchain-based investment systems, and more specifically to platforms that enable transparent, secure, and inclusive business funding using tokenized assets, smart contracts, and immutable on-chain identity systems.

### BACKGROUND

Conventional investment and fundraising systems often present barriers for small and medium-sized enterprises (SMEs) due to limited access to capital, high intermediary fees, regulatory complexity, and inefficient reporting mechanisms. These centralized models frequently lack transparency, leaving both investors and businesses without real-time visibility into fund allocation, business performance, or compliance status.

At the same time, retail investors face significant challenges in participating in early-stage funding opportunities. These include high minimum investment thresholds, limited access to private deals, and insufficient tools for evaluating business proposals or tracking progress after investment.

Advances in blockchain technology have created new opportunities to decentralize finance and improve the flow of capital through the use of tokenized assets, smart contracts, and immutable digital identities. However, many existing blockchain-based investment platforms still suffer from poor usability, limited compliance frameworks, and lack of integration with real-world business operations.

There is a need for a decentralized, secure, and transparent investment ecosystem that simplifies participation for both businesses and investors, supports compliance and accountability, and bridges the gap between blockchain-native tools and traditional financial expectations.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

The disclosed embodiments provide systems, methods, and computer-readable media for enabling transparent, decentralized business funding through a blockchain-based platform. In contrast to conventional fundraising systems that suffer from limited access, opacity, and inefficient reporting, the system introduces a secure and automated investment ecosystem that integrates smart contracts, non-fungible token (NFT) identities, and real-time performance tracking.

In one embodiment, a method is provided for managing decentralized business funding. The method includes receiving a funding proposal via a decentralized application (dApp), verifying that the proposing entity possesses a verified identity NFT containing compliance and historical data, and publishing the proposal to an investor interface accessible according to tiered NFT membership. Investment commitments are immutably stored on a blockchain, and upon reaching a funding threshold, a smart contract executes to formalize the agreement and facilitate milestone-based disbursement of funds and returns to investors.

In another embodiment, a system is disclosed comprising a blockchain network, a decentralized interface, and a computing platform that coordinates proposal submissions, investor commitments, and tokenized return flows. Each business and investor is linked to a unique identity NFT, ensuring on-chain accountability. The system further supports a dual-token framework involving a blockchain-native token and a fiat-pegged in-app credit to improve usability and integration with traditional finance.

In a further embodiment, a computer-readable medium stores instructions that enable a computing system to perform the functions of proposal creation, identity verification, milestone tracking, and investor return calculation. The system may be integrated with customer relationship management (CRM) tools to provide real-time operational transparency.

The disclosed system overcomes the shortcomings of conventional investment systems by lowering participation barriers, enforcing compliance via immutable records, reducing intermediary friction, and enabling retail investors to engage directly in early-stage business opportunities. It also empowers businesses to present verifiable, data-driven proposals and receive funding tied to measurable outcomes.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a system architecture diagram, according to some embodiments;

FIG. 2 illustrates an application program and modules in communication with the computing system, according to some embodiments;

FIG. 3 illustrates a flowchart of a digital certificate management process, according to some embodiments;

FIG. 4 illustrates a proof of value verification token valuation mechanism, according to some embodiments;

FIG. 5 illustrates a flowchart of the token cycle, according to some embodiments;

FIG. 6 illustrates a flowchart of the fee schedule, according to some embodiments;

FIG. 7 illustrates a flowchart of an exemplary process for new sources for revenue, according to some embodiments;

FIG. 8 illustrates a flowchart of the tiers process, according to some embodiments;

FIG. 9 illustrates a flowchart for an investment method process, according to some embodiments;

FIG. 10 illustrates a flowchart of a refund pool operation for investors, according to some embodiments; and

FIG. 11 illustrates a flowchart of the smart contract responsibilities, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

A decentralized funding platform may include various components and modules that interoperate to facilitate secure and transparent investment processes. In general, the platform may support the creation and evaluation of funding proposals, the use of verifiable identities, and the automated enforcement of investment terms through smart contracts deployed on a blockchain network.

A business entity may access the platform via a decentralized application (dApp) to submit a funding proposal. The proposal may include data fields such as a requested funding amount, funding terms, intended use of funds, and links to business performance metrics. The dApp may include a user interface for inputting proposal details and uploading documentation, which may then be cryptographically hashed and stored on a blockchain or an associated off-chain repository with verifiable integrity proofs.

To authenticate the proposing entity, the platform may require association with a non-fungible token (NFT)-based identity. This identity NFT may contain immutable, on-chain records representing compliance information (e.g., Know Your Customer (KYC) credentials), historical business performance, previous funding campaigns, and regulatory attestations. The system may verify this identity using a smart contract that checks the existence and integrity of the NFT metadata.

Once verified, the funding proposal may be published to an investor-facing interface. Access to funding proposals may be gated based on tiered NFT membership, where investors may hold NFTs corresponding to different levels of platform privileges. These levels may determine the types of proposals that are visible to a given user, participation limits, and access to proposal-specific data.

The dApp may also support submission of investment commitments. Investors may select proposals of interest and allocate a desired amount using either a blockchain-native token or a fiat-pegged in-app credit. The system may receive the investment data and immutably record it on the blockchain. If the sum of investments reaches or exceeds a predetermined funding threshold, a smart contract may be triggered to formalize the agreement between the business and the contributing investors.

The smart contract may encode the proposal terms, including conditions for milestone-based fund release, rights to returns, and profit-sharing percentages. The system may further integrate with a Customer Relationship Management (CRM) platform used by the business entity. This CRM integration may allow automated reporting of real-time sales, inventory status, or operational metrics relevant to verifying milestone achievement. The smart contract may evaluate incoming CRM data or associated oracle feeds and may control the release of funds accordingly.

If proposal milestones are met, return payments may be distributed to investors using a blockchain-native token. These distributions may be automated through smart contracts and logged on-chain for auditability. In some implementations, a platform support fee may be deducted from the distributed funds and directed to an operational wallet or community treasury address.

The system may require investors to complete identity verification using NFT-based KYC credentials. These NFTs may be soulbound and non-transferable to ensure traceability. Additionally, investors may be required to pay a one-time affiliation fee to access certain business proposals or funding rounds. Proposal-specific communication modules may also be provided, allowing investors to submit questions or comments viewable by the proposal originator.

In cases where the funding threshold is not reached, the system may be configured to return the committed investments to contributors automatically. The refund logic may be implemented in the smart contract associated with each proposal.

A computing system may include one or more processors and associated memory storing instructions to generate and manage the NFTs, execute smart contract logic, process investment transactions, and interface with external systems such as blockchains and CRMs. The computing system may also maintain a mapping between identity NFTs and historical records, proposals, and funding outcomes.

The platform may further include a dual-token framework. The blockchain-native token may be used for on-chain transactions and investor returns, while the fiat-pegged in-app credit may improve accessibility for users less familiar with digital assets. A conversion module may enable users to exchange one form of token for the other based on real-time exchange rates, recorded either off-chain or through decentralized oracles.

A proposal management module may orchestrate the proposal lifecycle, including submission, evaluation, status updates, fund disbursement, and performance tracking. This module may integrate with other components such as smart contracts, identity verification services, and token distribution logic.

In some implementations, a non-transitory computer-readable medium may store software instructions that, when executed, implement the entire investment process described above. The medium may also include logic for tracking individual investment performance, calculating milestone-based bonuses, updating investor dashboards, and integrating with decentralized marketplaces for product promotion.

Profit-sharing agreements may be tokenized such that investors receive a tradable representation of their rights to revenue or profits. These tokens may be exchanged on secondary markets or staked for additional rewards. Risk assessment modules may also be included to evaluate business proposals using AI-based analysis of historical data, peer benchmarks, and market indicators.

The system architecture may support community governance mechanisms, including token-weighted voting on disputes or platform updates. Dispute resolution may be automated through smart contracts triggered by community consensus or through dedicated arbitration modules.

Various implementations of the invention involve the technical field of platforms that enable transparent, secure, and inclusive business funding using tokenized assets, smart contracts, and immutable on-chain identity systems including receiving, via a decentralized application (dApp), a funding proposal from a business entity, the funding proposal comprising a requested funding amount, funding terms, and intended use of funds; verifying, using a smart contract stored on a blockchain network, that the business entity possesses a verified non-fungible token (NFT) identity comprising on-chain compliance and performance data; publishing the funding proposal to an investor-facing interface, wherein the proposal is accessible to users based on tiered NFT membership levels; receiving investment commitments from one or more investors via the decentralized application; storing each investment commitment immutably on the blockchain network; executing a smart contract to enforce a binding agreement between the business entity and the investors upon reaching a predetermined funding threshold; and distributing, upon fulfillment of proposal milestones, return payments to the investors using a blockchain-native token, and are therefore necessarily rooted in computer technology. For example, the aforementioned steps are inherently computer-based and cannot be performed in the human mind. Additionally, the steps of the present invention would be impossible to accomplish on pen and paper due to the volume of data being communicated and received over a network in real-time. In particular, the speed at which the steps of the present invention occur to effectuate the disclosed method, system, or product would involve large-scale, continuous wireless communication of such data. That is, the steps of the present method, system, or product are impossible to accomplish on pen and paper, cannot be accomplished as a method of organizing human activity, and amount to significantly more than merely gathering, analyzing, and outputting data.

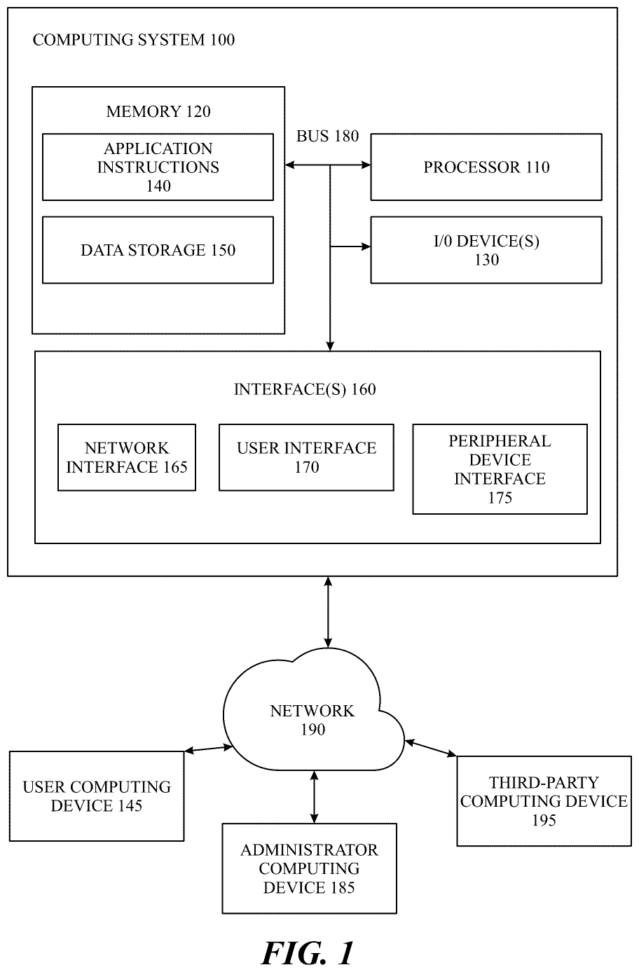

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computer system 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 140, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C #, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized by a user to interact with the various functionalities of the system. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

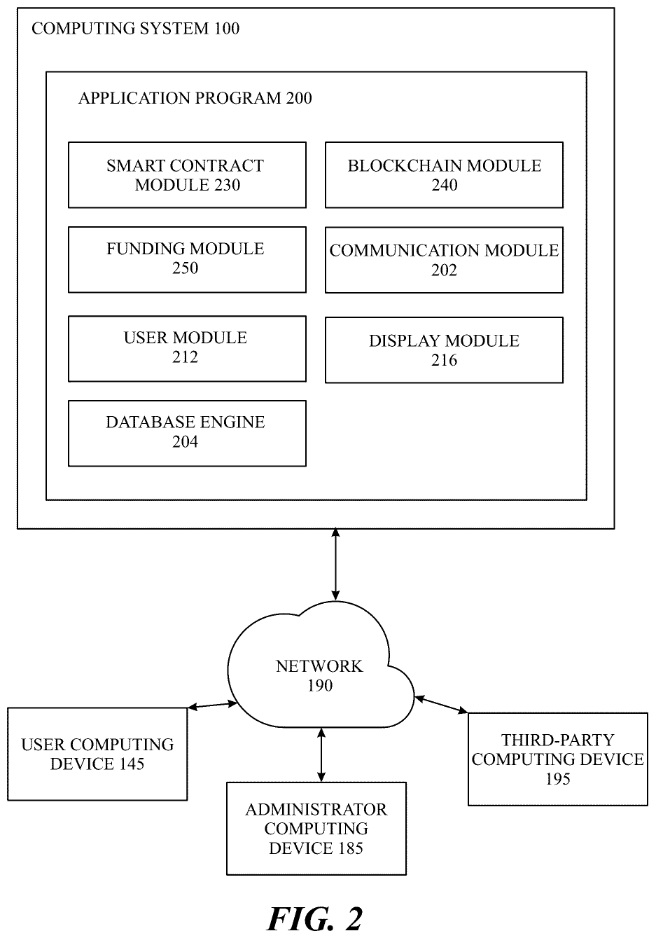

FIG. 2 illustrates an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a smart contract module 230, a blockchain module 240, a funding module 250, a communication module 202, a database engine 204, a user module 212, and a display module 216.

In some embodiments, the smart module 230 is configured to manage smart contract-based logic that governs identity verification and investment execution within a decentralized funding system. The module may operate in conjunction with a blockchain network and serve as an autonomous mechanism for enforcing conditions encoded in smart contracts. The smart module 230 may be configured to verify that a business entity possesses a verified non-fungible token (NFT) identity comprising on-chain compliance and performance data. This verification may occur upon submission of a funding proposal and may involve querying the metadata of the business's NFT using a blockchain read operation. The NFT may encode regulatory compliance indicators, KYC (Know Your Customer) status, and historical funding or operational metrics. The smart module 230 may evaluate the integrity and structure of this data and determine whether the NFT satisfies predetermined eligibility requirements for publishing a proposal on the platform. In addition to identity verification, the smart module 230 may be further configured to execute a smart contract to enforce a binding agreement between the business entity and one or more investors. This execution may occur upon detecting that cumulative investment commitments stored on the blockchain meet or exceed a predetermined funding threshold. The smart contract may include terms submitted as part of the proposal, such as the amount to be raised, payment schedules, revenue sharing rules, and milestone conditions. When triggered, the smart module 230 may broadcast a blockchain transaction to instantiate the contract, lock or transfer the committed funds, and initiate post-funding conditions, such as milestone tracking and token-based return distribution. The smart module 230 may also interface with off-chain or on-chain data sources to verify ongoing compliance and progress, including integrating with business-facing systems like CRMs or external oracles to support milestone-based disbursement logic. The use of deterministic execution via the underlying blockchain may help ensure that verification and enforcement are tamper-resistant and transparent.

In some embodiments, the blockchain module 240 is configured to record and maintain immutable investment-related data on a distributed ledger. The module may be implemented using smart contract-compatible blockchain infrastructure such as Ethereum, Polygon, or another EVM-compatible network, though permissioned chains or Layer 2 solutions may also be used depending on scalability or compliance considerations. The blockchain module 240 may be responsible for storing investment commitments submitted by investors through the decentralized application (dApp). Upon receiving a commitment, the module may encode the transaction into a blockchain-compatible format and broadcast it to the network. Each commitment may include data such as investor identity, funding amount, linked proposal ID, timestamp, and any associated terms or membership tier. Once validated, this data may be included in a confirmed block, rendering it immutable and accessible for subsequent auditing or triggering downstream smart contract logic. The blockchain module 240 may interface directly with smart module 230 to ensure that real-time investment totals are accurately tracked and that proposal-specific smart contracts are triggered once predefined thresholds are met. Additionally, the module may support on-chain access controls, enabling the platform to limit read/write privileges based on cryptographic credentials associated with each user's NFT-based identity. In some implementations, the blockchain module 240 may also participate in recording milestone completions, disbursement transactions, and return payments to investors. By ensuring that all material events in the investment lifecycle are verifiably logged on-chain, the module may facilitate transparency, reduce reliance on intermediaries, and provide a tamper-evident record of investor and business activity.

In some embodiments, the funding module 250 is configured to manage the lifecycle of funding proposals, from submission to capital distribution. The module may serve as the central orchestrator for investor-business interactions, integrating user interfaces, smart contract logic, and external data sources to facilitate decentralized investment operations. The funding module 250 may be configured to receive funding proposals from business entities via a dApp interface. These proposals may include fields such as requested funding amount, proposed return structure, use of funds, and optional linked documents or CRM data feeds. The module may parse and validate the proposal data, associate it with the business's verified NFT identity, and prepare it for review and publication. Once verified, the funding module 250 may publish the proposal to an investor-facing portal. Visibility of each proposal may be gated based on NFT membership tiers, with the module enforcing tiered access logic. For example, users holding specific NFTs may be granted early or exclusive access to high-profile opportunities or additional performance data. The funding module 250 may also handle the intake of investment commitments from investors via the dApp. Commitments may be submitted using either blockchain-native tokens or fiat-pegged in-app credits. The module may validate the investor's identity and membership status, confirm proposal eligibility, and route the commitment to blockchain module 240 for immutable recording. Upon successful funding and verification of milestone achievements, potentially supported by CRM integrations, the funding module 250 may initiate disbursement of return payments to investors. These payments may be calculated using smart contract logic and transacted using blockchain-native tokens. The module may interface with smart module 230 to ensure that each disbursement adheres to the encoded contractual terms and may optionally deduct platform fees before release. The funding module 250 may further support refund logic in cases where proposals fail to meet funding thresholds, as well as communication tools allowing investors to interact with business entities during active proposal periods.

In some embodiments, the communication module 202 is configured for receiving, processing, and transmitting a user command and/or one or more data streams. In such embodiments, the communication module 202 performs communication functions between various devices, including the user computing device 145 of FIG. 1, the administrator computing device 185 of FIG. 1, and a third-party computing device 195 of FIG. 1. In some embodiments, the communication module 202 is configured to allow one or more users of the system, including a third-party, to communicate with one another. In some embodiments, the communications module 202 is configured to maintain one or more communication sessions with one or more servers, the administrative computing device 185 of FIG. 1, and/or one or more third-party computing device(s) 195 of FIG. 1. In some embodiments, the communication module 202 may allow users and administrators to communicate with one another.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

The user module 212 may store user preferences including the user account information, historical usage data, user personal information, and the like. The user module 212 may facilitate the creation of user's profiles for users, administrators, and others.

In some embodiments, the display module 216 is configured to display one or more graphic user interfaces, including, e.g., one or more user interfaces. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored. The display module 216 displays information, notifications, and alerts to the user device which can be viewed and acknowledged by the user.

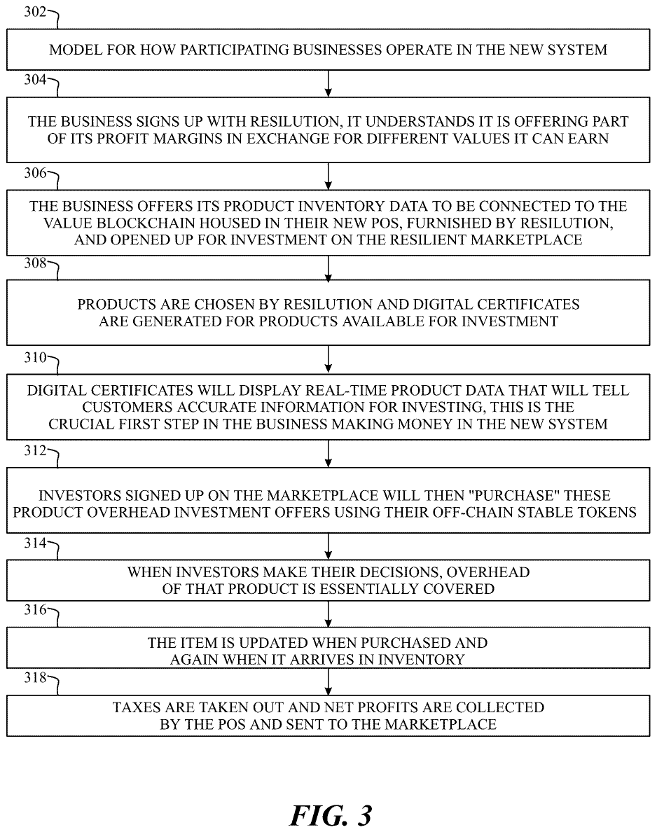

FIG. 3 depicts a process model for how participating businesses may operate within a decentralized funding ecosystem. At step 302, a business may enroll with the Resilution platform and agree to offer a portion of its profit margins in exchange for access to blockchain-enabled investment tools and value-based participation. At step 304, the business may connect its product inventory data to a blockchain-based point-of-sale (POS) system provided by the platform. This system may allow selected inventory items to be tokenized and made available for investment through the Resilient marketplace. At step 306, the platform may generate digital certificates for eligible products. These certificates may contain real-time product data and serve as tokenized representations of inventory available for overhead investment. In step 308, these digital certificates may be published to the marketplace, where investors can access detailed metrics such as popularity, sales velocity, or overhead costs to inform investment decisions. At step 310, investors may use off-chain stable tokens to participate in product overhead investment offers. These tokens may represent fiat-backed value within the system and may be used to cover the costs of bringing inventory into the store. Once investment decisions are made (step 312), the business may consider the overhead for the selected products fully funded. This may trigger product acquisition processes or purchase orders. At step 314, the product's status may be updated in the system when it is purchased and again when it is received into inventory. These updates may be logged using barcode scans and reflected in the associated digital certificates. At step 316, after the product is sold to an end customer, the POS system may automatically deduct applicable taxes and transfer net profits to the marketplace. At step 318, these net profits may be used to repay investors according to the terms encoded in associated smart contracts, including the return of funds in Resil tokens.

The system enables various metrics to be assessed. The increasing value of the token reflects both the perceived value and utility of the system, as well as general market sentiment. As more businesses and users engage with the system, the demand for the token rises, indicating both the tokens and the system's usefulness. The token's value is ultimately determined by its real-world utility and acceptance in transactions.

If token values fluctuate unsustainably, a non-fluctuating off-chain stable token can be used instead of the on-chain reward token for access and returns, avoiding volatility entirely. Although the system could technically operate using fiat currency alone, blockchain enhances the system's capabilities. These improvements have been incorporated from the start.

Core developers and founders govern the system. Governance under a Proof-of-Value verification (PoVv) model may allow holders of a certain number of tokens or specific NFTs to participate in decision-making. Off-chain transactions occur outside the blockchain and are backed by real-world value (e.g., USD). This allows each token to remain pegged at $1. Such stability is crucial when making purchase orders with wholesalers or distributors. The fiat backing the off-chain stable tokens is stored in the marketplace's main accounts. Once investment terms are met, fiat is used to complete purchase orders. As long as fiat funds remain untouched for overhead costs, off-chain tokens can be redeemed 1:1 for USD.

Off-chain stable tokens, branded “Stabill,” will be purchased by both business owners and investors. Each token is backed by an equivalent amount of fiat held in the marketplace's main account. For example, a $100 purchase from a user's bank account would mint 100 Stabill tokens (each valued at $1) for use within the marketplace. There is no cap on the number of tokens that can be generated for overhead investments, and the token's value will not deviate from $1. Tokens are burned when spent or redeemed, maintaining price stability and reducing volatility in fulfilling purchase orders. Token demand is driven by marketplace participation. Business owners'accounts receive net profits from product sales and redistribute them to investors in the form of resilient tokens, branded “Resil” tokens.

On-chain transactions occur on the V.A.L.U.E. blockchain and are subject to market-driven fluctuations. All transactions are recorded on-chain for transparency. Business owners drive demand for the on-chain Resil token as they need it to repay investors. Marketplace customers further drive demand by seeking investment opportunities.

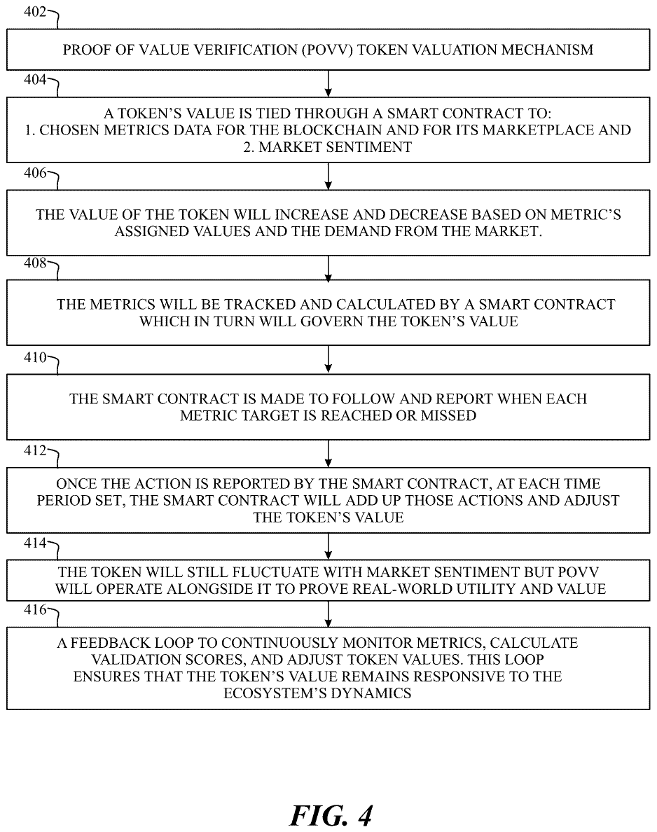

FIG. 4 illustrates a token valuation mechanism based on a Proof of Value verification (PoVv) model. The diagram outlines how a smart contract may tie the value of a token to both selected metrics and overall market sentiment. At step 402, the system may define specific metrics relevant to the blockchain and its associated marketplace, such as user growth, transaction volume, or business activity. These metrics may be tracked and calculated in real time by a smart contract, as shown in step 404. In step 406, the smart contract may evaluate whether each metric has reached or missed a predefined target. The smart contract may then report this status and adjust token value accordingly at defined time intervals, as shown in step 408. For example, if a user growth milestone is achieved, the smart contract may increment the token value by a set amount; if targets are missed, the token value may decrease. At step 410, this adjustment process may be repeated at each time period, aggregating multiple data points to refine the valuation. Although market sentiment may still influence token pricing, the PoVv mechanism operates in parallel to reinforce real-world utility as a factor in valuation. As shown in step 412, the system may include a feedback loop that continuously monitors metric outcomes, calculates validation scores, and adjusts the token's value, as indicated in step 414. This ongoing recalibration may ensure that the token remains responsive to actual usage patterns and ecosystem activity, as summarized in step 416.

Token releases are tied to ecosystem growth. When demand rises organically, releasing additional tokens in small increments (e.g., 21 million) helps avoid oversupply. Tokens held in locked vaults do not affect circulating supply and may even increase token value due to induced scarcity.

After the Initial Token Offering (ITO), Resil tokens can only be acquired by investing in product overhead through the marketplace or by purchasing from existing holders. This model prevents large-scale investors (“whales”) from disrupting the system. No on-chain Resil tokens will be burned unless decided by the founders. Token cycles will continue until full circulation is reached.

The ITO fund will follow rules defined by the founders. With a token price of $1 and a supply of 100 million tokens, the soft cap is $ 1 million (if 1 million tokens are sold), and the hard cap is $100 million (if all are sold). ITO purchasers may:

Enter a tiered marketplace early and invest before others;

Sell Resil tokens to businesses who need to repay investor returns. Business owners'accounts receive product sale profits via POS, use those funds to buy Resil tokens, and redistribute them to investors.

Once the initial 100 million tokens are distributed, the remaining tokens will be released in 21 million increments as demand requires. After each full tranche is purchased, a new set is made available. This continues until full circulation. In phase three, when 100 billion tokens are in circulation, the ecosystem will support new and advanced capabilities.

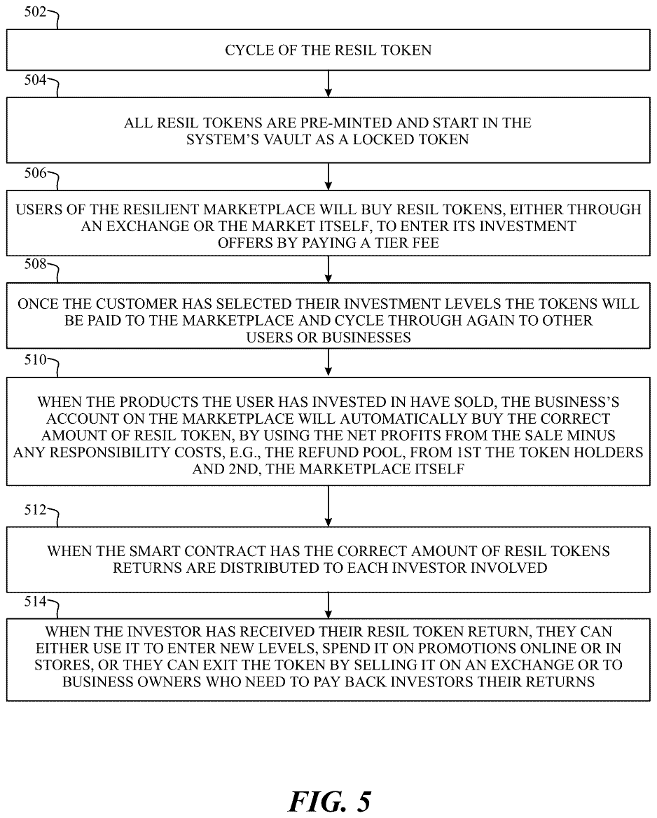

FIG. 5 depicts a cycle model for the Resil token within the Resilution marketplace ecosystem. At step 502, all Resil tokens may be pre-minted and stored as locked tokens within a system vault. At step 504, users may obtain Resil tokens either through an external exchange or directly from the marketplace in order to pay tier access fees and participate in investment opportunities. After selecting their desired investment level, users may pay the tier fee using Resil tokens, which are then cycled back into the system for redistribution (step 506). Once the products selected for investment are sold at retail, the business's marketplace account may use net profits from the sales, minus responsibility-related deductions such as contributions to a refund pool, to repurchase the appropriate amount of Resil tokens from circulating supply (step 508). These repurchases may first draw from existing token holders and, if needed, from the marketplace's reserve supply. In step 510, once the appropriate number of tokens is acquired, a smart contract may be executed to distribute the returns proportionally to each investor who participated in the product's overhead funding. At step 512, investors receiving Resil tokens as returns may choose to reinvest, use the tokens for promotions or purchases, or exit by selling them to other participants or back to business owners needing tokens to fulfill investor returns, as shown in step 514. This continuous flow of token acquisition, distribution, and reinvestment defines the operational lifecycle of the Resil token

Blockchain transaction fees (termed “energy costs”) are designed to be fair and efficient:
$0.01-$99: $0.10 or 0.1%
$100-$999: $0.10-$0.99 or 0.1%
$1,000-$9,999: $1-$9.99 or 0.1%
$10,000-$99,999: $10-$99.99 or 0.1%
$100,000-$999,999: $100-$999.99 or 0.1%
$1,000,000+: $1,000 or 0.1%

These fees deter spam, reward validators, and maintain system health. They also provide new revenue streams and protection for participants.

Energy costs and tier fees are collected into a pool. The pool is divided into four equal parts and distributed via smart contracts for designated purposes, e.g., store payouts, operator payments, etc.

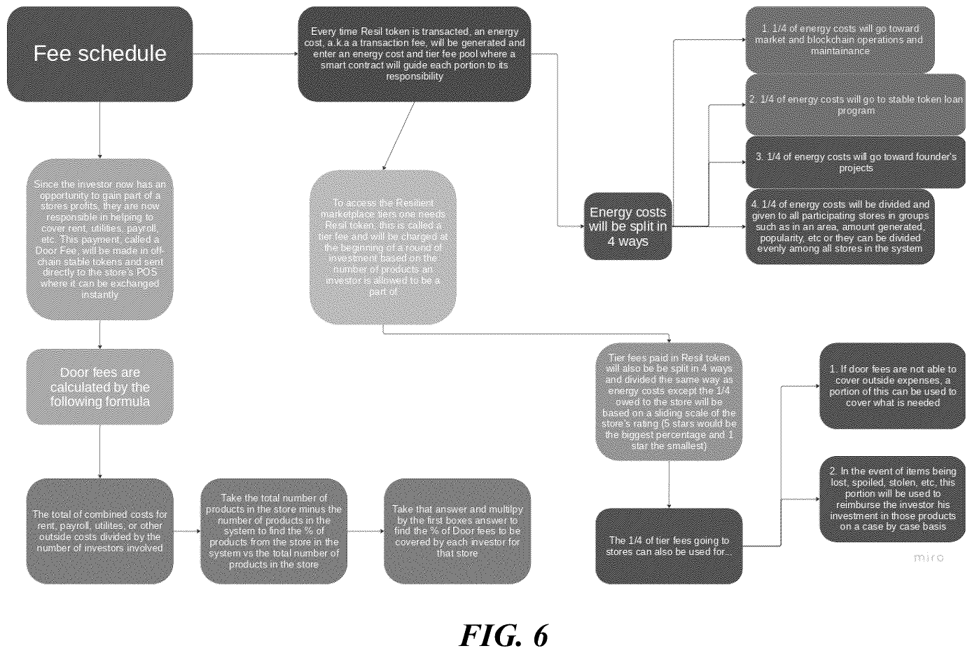

FIG. 6 illustrates a system-level view of the Resilution platform operating in conjunction with a virtual boundary 600 in an operating environment 602, such as a commercial retail or investment marketplace. The system may include one or more wearable or embedded computing components such as smart contracts, point-of-sale (POS) systems, investor interfaces, and marketplace infrastructure. Data flows throughout the system via a network 190 that may connect business devices, investor interfaces, administrative tools, and third-party systems. FIG. 6 may visually represent components of the investment infrastructure, including product inventory tracking, digital certificates, funding flows, and return logic, as they operate within defined system constraints or participation rules. These virtual boundaries 600 may be defined by token-based permissions or NFT access tiers, and may govern who can access certain investment offers, how funds are distributed, and under what criteria product data becomes visible or actionable. The system may monitor these interactions in real time and enforce policy rules dynamically through smart contract logic, forming a closed-loop investment environment 602 with built-in transparency and accountability. Investors browsing the marketplace will see featured stores/products ranked by profitability or user rating. They can explore investment tiers, view product data, and assess opportunities without purchasing.

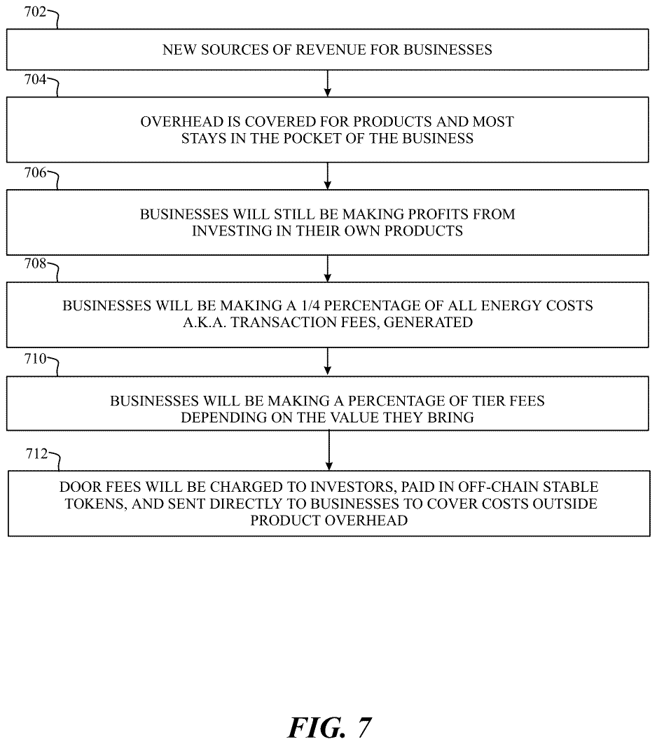

FIG. 7 illustrates various revenue sources available to businesses participating in the Resilution ecosystem. At step 702, product overhead costs may be covered by investors using off-chain stable tokens, allowing businesses to retain more of their sales revenue. At step 704, businesses may also invest in their own products, enabling them to earn profits as both sellers and investors. At step 706, businesses may receive a portion, such as one-quarter of the energy costs generated from transaction fees within the marketplace. These fees may be collected whenever Resil tokens are transferred and may be distributed proportionally to participating businesses based on activity or participation metrics. At step 708, businesses may earn an additional percentage of tier fees paid by investors to access investment opportunities, with the percentage varying based on the value the business provides to the ecosystem. At step 710, investors may also be charged door fees, which may be calculated based on store performance and the investor's participation. These door fees, paid in off-chain stable tokens, may be sent directly to business accounts or POS systems to cover expenses unrelated to product overhead, such as rent, utilities, and payroll, as shown in step 712. Tiers are based on: Number of accessible products, Investment amount, and Number of co-investors. Each tier requires a fee paid in Resil tokens. Tiers may also be accessed via NFTs, which grant privileges and allow tokenized value purchases within the ecosystem. NFTs carry embedded royalties, benefiting lenders, stores, and operators. After selecting their tier, investors pay the tier fee, gaining access to a set number of product investments via digital certificates. These are added to a virtual cart. On checkout, the system displays a breakdown: total investment, refund pool contribution, door fees, and energy costs. Upon confirmation, the system records the investor's chosen certificates and locks their participation until the next inventory cycle.

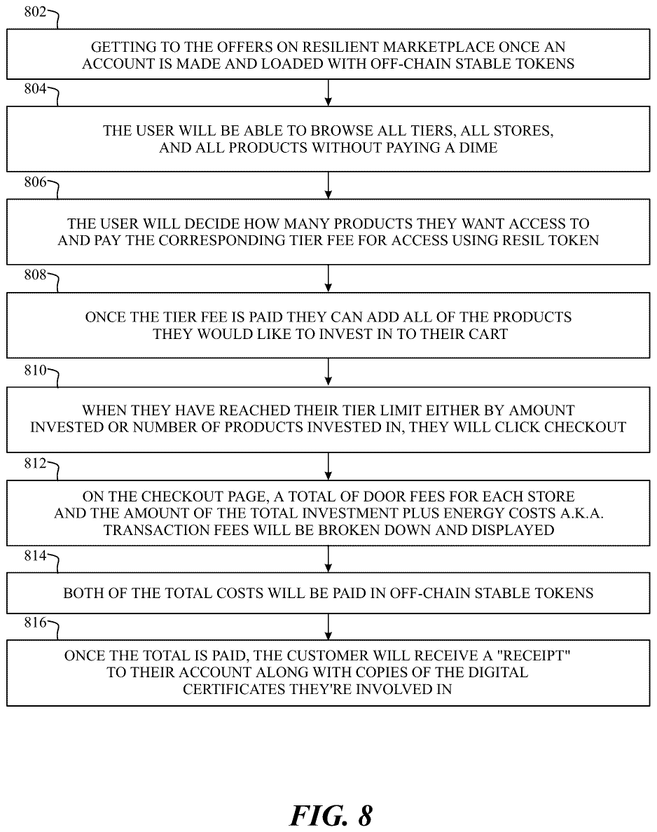

FIG. 8 illustrates a user flow for accessing and participating in investment offers on the Resilution marketplace once an account has been created and funded with off-chain stable tokens. At step 802, the user may browse all available tiers, stores, and product offerings on the platform without incurring any upfront cost. At step 804, the user may determine the number of products they wish to invest in and pay a corresponding tier fee using Resil tokens to unlock access. Upon successful tier entry, the user may add selected investment offerings, represented by digital certificates, to their cart, as indicated in step 806. At step 808, once the user has reached their investment limit, whether by quantity or value, they may proceed to check out. The checkout interface, shown in step 810, may provide a breakdown of applicable door fees for each store involved, the total investment amount, and energy costs, all denominated in off-chain stable tokens. At step 812, the user may confirm and pay the total amount using their stable token balance. Upon completion, as noted in step 814, the user may receive a receipt and secure copies of their digital certificates, which represent their active investments within the system. The marketplace will operate a proprietary, failure-resistant banking model. Rather than functioning like a traditional bank that offers funds to investors through accounts, the system reinvests a portion of its profits, generated through self-investment or network transaction fees, into a cyclical investment mechanism. Profits and fees are first converted into fiat, then into stable tokens, which may be loaned or reinvested. Revenue is generated by charging interest on stable token loans, collecting network energy fees, and investing in overhead contracts.

Loans may also be secured using NFTs owned by customers. For example, a one-year NFT with tier access and profit-generating rights could serve as collateral. Loans and profits derived from the system cannot be withdrawn until repayment, including interest, is completed. This entire loan operation will be facilitated through an off-chain stable token loan portal.

In some embodiments, the marketplace may operate its own loan program using profits, stable token conversions, or accumulated fees. Loans may be issued based on the value of NFTs held by a user or other verifiable blockchain-based collateral. If an investor holds a significant amount of liquid assets, as can be transparently verified on the blockchain, the system may also offer loans based on that observed liquidity. This allows the platform to extend credit in a decentralized and data-driven manner without relying on traditional credit scores.

In some embodiments, the system may be configured to offer loans or microloans to investors based on an on-chain credit score. The on-chain credit score may be generated by analyzing a variety of blockchain-derived metrics associated with an investor's wallet address, such as transaction frequency, repayment history, token holdings, duration of wallet activity, staking behavior, and participation in prior funding proposals. The score may be computed using a weighted algorithm or smart contract logic and updated at regular intervals or upon key events. This score may be used by the marketplace's loan module to assess creditworthiness and determine eligibility or terms for loan offerings without reliance on traditional financial data. The score may be stored on-chain or off-chain, and may be referenced during loan origination to support automated decision-making.

In some embodiments, the system may include a reputation tracking mechanism that uses on-chain data to assess and maintain the credibility of both investors and business entities. Reputation scores may be derived from transparent blockchain activity such as historical investment behavior, successful funding completions, refund history, fulfillment of obligations, dispute outcomes, and community ratings. This information may be recorded immutably on the blockchain and referenced by smart contracts to adjust access privileges, tier eligibility, or loan and funding terms. By making reputation metrics auditable and tamper-resistant, the system may discourage fraudulent activity and incentivize consistent, trustworthy behavior among participants.

In some embodiments, each identity-based non-fungible token (NFT) issued to an investor or business entity may include an embedded expiration policy designed to enhance security and reduce fraud. If an NFT remains unused in any qualifying transaction or system interaction for a predetermined time period, such as one year, the system may automatically mark the NFT as inactive or “dead.” This deactivation may be recorded on-chain and recognized by smart contracts as a revocation of identity credentials. The dormant NFT may no longer grant access to investment tiers, proposal submissions, or marketplace functions until revalidated. This feature may serve as an automated identity lifecycle control, similar to an on-chain social security number, and may help prevent stale or abandoned credentials from being exploited in fraudulent activities.

In some embodiments, the system may incorporate a smart contract-based escrow mechanism configured to hold investor funds in a secure state until the conditions of a funding agreement are satisfied. When an investor commits capital to a funding proposal, the contributed amount may be locked in escrow rather than transferred immediately to the business entity. The escrow contract may include predefined logic for evaluating proposal milestones, compliance criteria, or consensus validations. Upon detecting that the specified agreement terms have been fulfilled, such as confirmation of product delivery, milestone achievement, or compliance verification, the escrow contract may automatically release the funds to the business. If the terms are not met within a predefined time frame or a failure condition is triggered, the escrow may be refunded to the investors. This mechanism may ensure accountability and reduce the risk of misappropriation of investor capital.

A smart contract can be programmed to read a store's inventory API via product barcodes, generate digital certificates for each item or group, and immutably store those certificates on the blockchain. These certificates form the backbone of the system, providing investors with real-time, transparent information on store products through a public ledger. One smart contract can manage numerous certificates across single or multiple stores. Each certificate is uniquely linked to a product's barcode and includes metadata such as overhead costs, popularity, name, price, and inventory level. As products are scanned, smart contracts trigger automatic updates to certificates on-chain, creating a complete, transparent, and tamper-resistant record of each product's journey from manufacturer to consumer.

To build this smart contract system effectively, it's essential to determine all relevant data fields, such as product name, barcode, quantity, inventory thresholds, and pricing. The contract must define the data structures and the rules for creating, updating, and executing purchase orders. Additionally, smart contracts will interact with point-of-sale (POS) systems via APIs to reflect real-time inventory and sales data.

Through API integration, the smart contract will read and write data to and from the store's inventory system. When a sale occurs, the POS system triggers an API call to the smart contract to update the blockchain-based digital certificate. New certificates can also be generated for newly added products. Accuracy is ensured through automatic assignment of barcode identifiers to certificates.

These digital certificates will be stored on the blockchain and made accessible via the marketplace. Each certificate is a unique, verifiable record viewable by authorized users.

Both the store and users will interact with the data through a dashboard on the marketplace platform. This interface displays inventory levels, sales history, and customizable alerts for stock changes. Data access is secured through private keys. This dashboard will also allow viewing of product data chains.

Over time, these product data chains will offer structured insights into product performance. For example, if a product sells 84% of the time within two days over a six-month period, its data chain becomes a valuable tool for new business ventures. High-performing product data chains could influence future businesses, community projects, or token models, offering optimal investment opportunities and efficient supply chain practices.

While full integration with blockchain is possible, some stores may initially continue using traditional inventory tracking systems in parallel. APIs allow the POS system to communicate with blockchain smart contracts for enhanced supply chain visibility. Investors benefit by accessing details like product name, popularity, overhead cost, profit margin, and shelf life.

A simple, cost-effective blockchain inventory system can be built using current technologies and APIs. Integration with existing payment processors is feasible through standard API protocols.

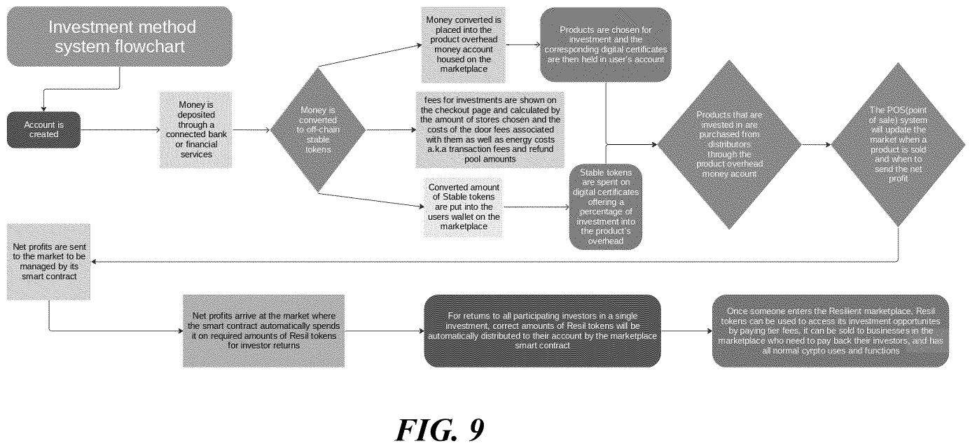

FIG. 9 illustrates a flowchart of a refund pool operation designed to manage investor returns in the event of customer product refunds. At step 902, investors agree to allow a portion of their net profits to be temporarily held in a refund pool, acknowledging the risk that refunds may be processed by stores on their behalf. At step 904, when a product sale occurs, a predefined percentage of net profits is automatically allocated to the refund pool. This pool may operate using a flowback mechanism, whereby withheld funds are eventually released back to the investor if unused. At step 906, the withheld percentage remains in the pool for a preset period, such as 30 days, corresponding to the store's refund policy. At step 908, once the time period expires, the smart contract may initiate the return of the held amount back to the original investor. As shown in step 910, newly earned investor profits may then replace the previously held funds, keeping the pool active. In step 912, this cycle continues automatically, ensuring liquidity in the refund pool while balancing investor protection and customer satisfaction. At step 914, this automated and auditable system allows refunds to be processed efficiently, with smart contracts handling validations and reimbursement conditions. A percentage of net profits will be held in the refund pool until a predetermined time limit. Once this expires, if no refund is claimed, profits are returned to investors via a flowback mechanism. A smart contract will verify returned items by scanning the barcode, checking that the product was purchased via the platform, and then processing the refund according to pre-established terms.

Each refund is recorded on-chain, making the process transparent and verifiable. Smart contracts prevent abuse by requiring proof of purchase before issuing refunds. If proof is not provided (via transaction record or barcode scan), the smart contract automatically rejects the refund request.

The smart contract can also detect suspicious refund activity by monitoring patterns and volumes. It will calculate reimbursement based on the store's investment and transaction data, ensuring that the business breaks even after issuing a refund.

### Refund Process Steps

A percentage of net profits is reserved in the refund pool.

The store scans the returned item's barcode.

A refund is issued from the POS system to the customer.

The smart contract reads all transaction data from the digital certificate.

The refund pool reimburses the store the break-even amount.

If the item is reusable, it is re-listed, and the certificate is updated.

The system operates with five key account types:

Token wallets

Business accounts (for profits, products, and taxes)

Investor accounts (linked to user bank accounts)

Product overhead fiat accounts (backing off-chain stable tokens)

NFT tier/tokenized value accounts

Business and customer onboarding includes:

Business account registration

Purchase of blockchain-based POS

Linking inventory and overhead pricing via API

Acquiring off-chain stable tokens to invest in products before customers

Barcodes, certificates, and smart contracts generate and update product data (e.g., item name, cost, sales speed, shelf time, popularity). After investment terms are defined, product certificates reflect available investment “stocks.” Customers trade fiat for off-chain stable tokens and select products to invest in.

Once a contract's terms are fulfilled, fiat from the main account is used to complete the purchase order. The corresponding off-chain tokens are burned. When the product arrives at the store, it is scanned into inventory; digital certificates are updated. Upon sale, net funds (after taxes) are deposited into the business's account. That account purchases the correct amount of Resil tokens, first from users, then the marketplace, and distributes them to investors.

The POS system integrates with the blockchain and marketplace for transparent, secure operations. Sales and taxes are handled by the buyer, while taxes are automatically transferred to the business owner's tax savings account. Barcode scanners update inventories in real time via API communication with smart contracts. Purchase orders are generated and executed accordingly.

Once scanned into inventory, the product enters a waiting period. When sold, another scan updates the marketplace's digital certificate. Smart contract (1) logs sales and inventory; smart contract (4) executes profit distribution.

The platform will be accessible via website and app, with five primary pages:
Token Wallets: For fiat-to-token exchange and Resil token management
Business Portal: Inventory, metrics, digital certificate management
Investor Profile: Personal/banking info, connected wallets, NFT investments
NFT Tiered Investments: Access higher tiers using NFTs
Digital Certificates Page: Explore product offerings and invest using Stabill tokens

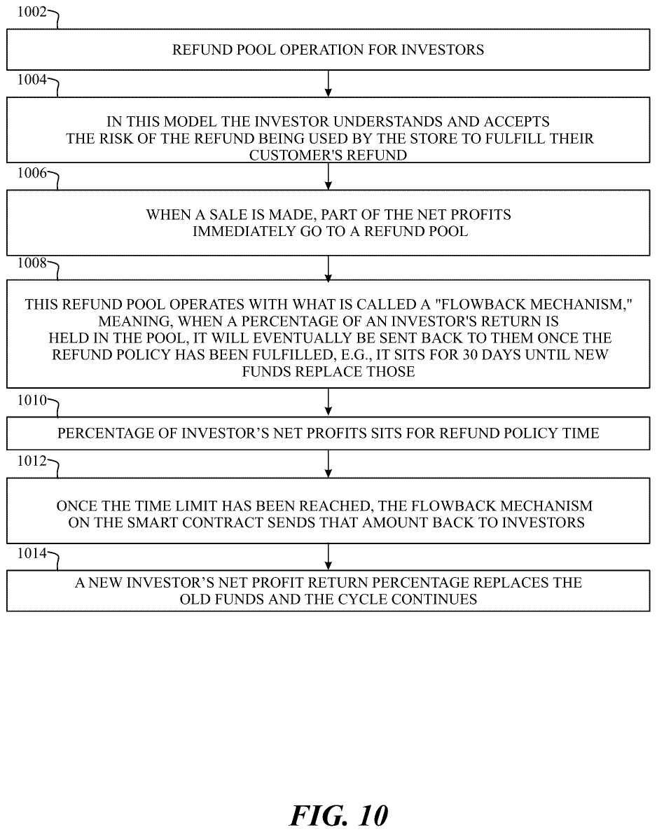

FIG. 10 illustrates a flowchart of the refund pool operation for investors within the Resilution marketplace. At step 1002, a portion of investor net profits may be held in a smart contract-governed refund pool immediately after a product is sold. This pool is designed to cover potential customer refunds initiated through the marketplace's point-of-sale system. At step 1004, if a customer requests a refund, the store may scan the product barcode, and the smart contract may validate the transaction by reading the associated digital certificate. At step 1006, the smart contract may calculate whether the product was originally sold, confirm the investment amount, and ensure the refund aligns with the predetermined refund terms. At step 1008, if validated, the smart contract may automatically reimburse the store from the refund pool to cover the cost of the returned item. At step 1010, the smart contract may also determine whether the store breaks even by calculating the net investment versus total funds spent. If applicable, the system may cycle the refunded product back into the marketplace, updating its digital certificate accordingly. At step 1012, if no refund is claimed within the designated holding period, the flowback mechanism may return the held amount to the original investor. This ensures fair treatment for both businesses and investors, while maintaining transparency and automated accountability through blockchain enforcement.

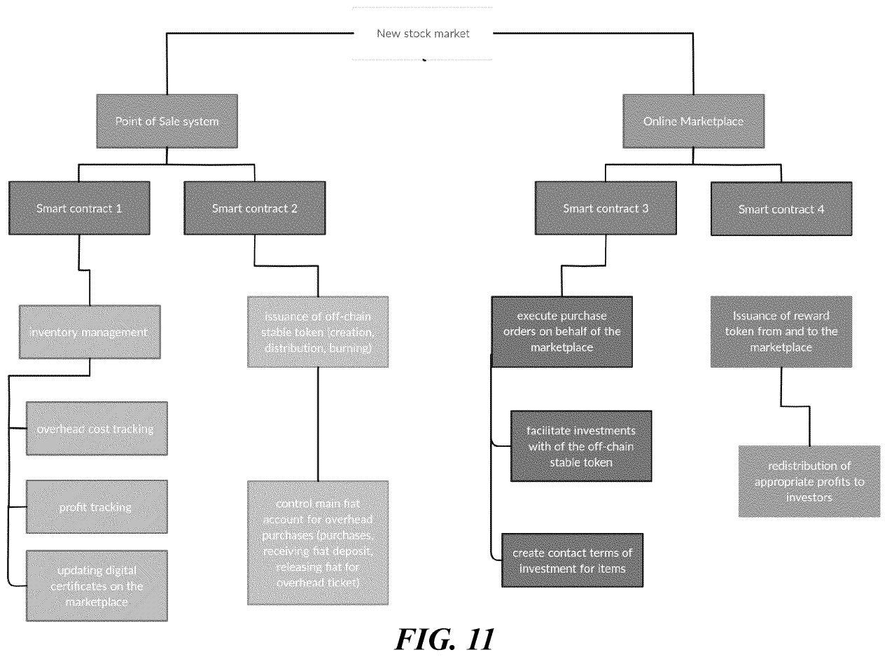

FIG. 11 illustrates a flowchart of a smart contract architecture for managing operations across the Resilution marketplace and its blockchain-based point-of-sale (POS) system. The figure shows how multiple smart contracts may interact with each other and with external APIs to manage key functions of the platform. Smart contract (1) may be configured to monitor inventory and overhead costs by communicating with the store's POS system through an API. This contract may generate, assign, and update digital certificates for products by capturing data from barcode scans, such as UPC codes, wholesale price, gross profit margin, tax data, and sales activity. Smart contract (2) may be responsible for the issuance, conversion, and burning of the off-chain stable token known as “Stabill.” It may also monitor the fiat reserve account to ensure stable token backing and release fiat to fulfill purchase orders when triggered by smart contract (3). Smart contract (3) may govern investment contracts, including the number of participants allowed per investment, share allocation, and purchase order execution using fiat funds from the marketplace's reserve. It may also encode investment terms and enforce stack limits. Smart contract (4) may manage the distribution of investor returns using on-chain Resil tokens. It may interface with smart contracts (1) and (2) to receive net sales data and taxes, then execute automated profit returns to investors. It may also manage NFT governance, including tier access, on-chain token flows, and allocation of tax savings to business accounts. Together, these smart contracts may provide an integrated, transparent framework for decentralized investment, sales tracking, and automated returns within the marketplace.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrases “computing device” or “central processing unit” as is used herein means a computer hardware component that executes individual commands of a computer software program. It reads program instructions from a main or secondary memory and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. A computer-implemented method for managing decentralized business funding, comprising:
receiving, via a decentralized application (dApp), a funding proposal from a business entity, the funding proposal comprising a requested funding amount, funding terms, and intended use of funds;
verifying, using a smart contract stored on a blockchain network, that the business entity possesses a verified non-fungible token (NFT) identity comprising on-chain compliance and performance data;
publishing the funding proposal to an investor-facing interface, wherein the proposal is accessible to users based on tiered NFT membership levels;
receiving investment commitments from one or more investors via the decentralized application;
storing each investment commitment immutably on the blockchain network;
executing a smart contract to enforce a binding agreement between the business entity and the investors upon reaching a predetermined funding threshold; and
distributing, upon fulfillment of proposal milestones, return payments to the investors using a blockchain-native token.

2. The method of claim 1, wherein the funding proposal includes CRM-linked real-time business data.

3. The method of claim 1, further comprising verifying investor identities using KYC-compliant NFT-based credentials.

4. The method of claim 1, wherein each investor is required to pay a one-time affiliation fee to access proposals from a specific business.

5. The method of claim 1, further comprising enabling investor interaction with the business entity via a proposal-specific Q&A interface.

6. The method of claim 1, further comprising automatically returning investor funds if the predetermined funding threshold is not met.

7. The method of claim 1, wherein the smart contract is configured to restrict fund release until business milestones are verified via CRM integration.

8. The method of claim 1, further comprising applying a platform support fee during fund release, used for operational costs and community grants.

9. A system for managing transparent business investment via blockchain, comprising:
a blockchain network configured to immutably store business proposals, smart contracts, and identity records;
a computing system comprising one or more processors and memory storing instructions that, when executed, cause the computing system to:
generate and assign a unique identity NFT to each participating business and investor,
record historical performance data associated with each identity NFT, and
link each identity NFT to one or more proposals submitted or funded through the system;
a decentralized application (dApp) interface configured to:
receive proposal submissions from businesses,
verify compliance and historical data of the proposal submitter,
receive and process investment commitments from verified investors;
a dual-token framework including a blockchain-native token and a fiat-pegged in-app credit, wherein investment commitments and returns are transacted using at least one of the two tokens; and
a proposal management module configured to execute funding, tracking, and reporting functions based on smart contract logic.

10. The system of claim 9, wherein the dual-token framework enables conversion between the blockchain-native token and the fiat-pegged in-app credit.

11. The system of claim 9, wherein the identity NFTs are soulbound and non-transferable to ensure authenticity.

12. The system of claim 9, wherein investor tiers determine access to premium proposals, real-time metrics, and governance features.

13. The system of claim 9, further comprising an automated dispute resolution module governed by community vote using token-weighted consensus.

14. The system of claim 9, wherein the proposal management module performs tokenized profit distribution using automated smart contracts.

15. A non-transitory computer-readable medium storing instructions that, when executed by a processor, cause a computing system to perform a method comprising:
automating the distribution of returns on investment (ROI) to investors based on pre-defined investment parameters, wherein a smart contract validates and executes ROI transactions without the need for intermediaries;
storing, via blockchain nodes, and validating data about business performance;
dynamically computing, via the smart contract, ROI based on metrics comprising business revenue, profit margins, or milestone achievements;
preventing, via the blockchain's immutable ledger, fraudulent manipulation of investment data, ensuring the ROI is based on accurate and verified business performance records; and
executing smart contracts that ensure ROI delivery between multiple blockchain platforms utilizing interoperable consensus algorithms and payment protocols.

16. The method of claim 15, wherein the ROI calculations are automatically updated in real-time based on the continuous input of business data and metrics into the blockchain.

17. The method of claim 15, wherein the smart contract leverages granular investment metrics comprising risk scores, transaction histories, and investor preferences to compute customizable ROI for individual investors.

18. The method of claim 15, wherein the smart contract uses predefined ROI parameters coded in WebAssembly (Wasm) language for seamless execution on blockchain platforms.

19. The method of claim 15, further comprising tokenizing peer-to-business investment agreements on blockchain to represent ownership stakes or future ROI entitlements as tradable digital tokens.

20. The method of claim 15, further comprising periodic assignment of ROI as dividends to digital wallets proportionate to the token holdings of investors; and
storing immutable records of all ROI transactions executed by the smart contract, ensuring transparency and traceability for all stakeholders.

21. The method of claim 15, further comprising offering a loan to an investor based at least in part on the investor's liquid asset holdings, wherein the liquid asset holdings are determined by evaluating on-chain wallet data visible through the blockchain network.

22. The method of claim 15, further comprising offering a loan or microloan to an investor based at least in part on an on-chain credit score, wherein the on-chain credit score is calculated using historical blockchain transaction data associated with the investor's wallet address.

23. The method of claim 15, further comprising tracking an investor's or business entity's reputation using on-chain data, wherein the reputation data is used to reduce fraudulent activity by influencing participation eligibility, access to proposals, or loan decisions.

24. The method of claim 15, further comprising automatically deactivating a non-fungible token (NFT) associated with an investor or business entity if the NFT remains unused for a predetermined period of time, wherein deactivation serves to prevent fraud by invalidating dormant identities and functions as an on-chain identity expiration mechanism.

25. The method of claim 15, further comprising holding investor funds in an escrow smart contract until predefined agreement conditions are met, wherein the escrow release is triggered automatically based on the evaluation of proposal milestones or compliance with funding terms.
